(19) United States
(12) Patent Application Publication
(10) Pub. No.: US 2008/0102773 A1
(43) Pub. Date: May 1, 2008

(54) Method and apparatus to facilitate use of intermodulation product results to control gain for a received wireless signal

(75) Inventors: GREGORY J. BUCHWALD, CRYSTAL LAKE, IL (US); LAWRENCE M. ECKLUND, WHEATON, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/554,956

(22) Filed: Oct. 31, 2006

(51) Int. Cl. H04B 1/06; H04B 1/10; H04B 7/00

(52) U.S. Cl. 455/232.1; 455/295

(57) ABSTRACT

A wireless receiver receives a desired wireless signal and then detects self-sourced intermodulation products other than with respect to the desired wireless signal to provide corresponding detected results. The wireless receiver then uses these detected results to control gain as corresponds to the desired wireless signal.

### TECHNICAL FIELD

This invention relates generally to controlling gain as corresponds to reception of a desired wireless signal.

### BACKGROUND

Wireless receivers of various kinds are known in the art. In many cases such a receiver will have one or more automatic gain control (AGC) functions associated with one or more amplifiers in the receiver, to facilitate controlling an amount of gain as is applied with respect to a desired received wireless signal. Such may be the case, for example, in a wideband receiver to thereby attempt to optimize the performance of the receiver in the presence of strong interfering signals.

By one prior approach, a separate wideband AGC circuit could be employed to protect the LNA (Low Noise Amplifier) and mixer from radio frequency signal overload even when also employing wideband radio frequency filtering. More recently, teachings exist that it may be preferable to cease using AGC capabilities when a very strong undesired signal appears contemporaneously with a weak desired signal. Although this permits the LNA and/or mixer to potentially overload, this approach also tends to assure some minimal level of performance. In such a case, poor quality of service (due to overloading of the LNA and/or mixer) seems preferable to no quality of service (due to inappropriate ranging of the AGC in response to the presence of the strong undesired signal).

Such a compromise, while potentially suitable for some application settings, nevertheless leaves much to be desired. While poor service may serve better than no service, there can be application settings where “poor” is also insufficient.

### BRIEF DESCRIPTION OF THE DRAWINGS

The above needs are at least partially met through provision of the method and apparatus to facilitate use of intermodulation product results to control gain for a received wireless signal described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention; and

FIG. 3 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Before describing in detail embodiments that are in accordance with the present invention, it should be observed that the embodiments reside primarily in combinations of method steps and apparatus components related to a method and apparatus to facilitate use of intermodulation product results to control gain for a received wireless signal. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus to facilitate use of intermodulation product results to control gain for a received wireless signal described herein. The non-processor circuits may include, but are not limited to, a radio receiver, a radio transmitter and user input devices. As such, these functions may be interpreted as steps of a method to perform the use of intermodulation product results to control gain for a received wireless signal described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Generally speaking, pursuant to these various embodiments, a wireless receiver receives a desired wireless signal and then detects self-sourced intermodulation products. The wireless receiver then uses these detected results to control gain as corresponds to the desired wireless signal.

These self-sourced intermodulation products can be detected by direct and/or indirect means. By one approach such products are detected using more than one technique, approach, and/or monitored parameter in this regard. These self-sourced intermodulation products can be detected by, for example, detecting such products on a channel other than a channel that carries the desired wireless signal (where those skilled in the art will recognize and understand that the expression “channel” represents a variety of bearer concepts, including, but not limited to, dedicated or dynamically assigned carrier frequencies, and dedicated or dynamically assigned spreading codes, and so forth).

By one approach, these self-sourced intermodulation products are in turn employed to control the adjustment of one or more automatic gain control (AGC) thresholds. This can be combined, if desired, with further information regarding a level of quality as corresponds to the desired wireless signal itself. For example, a present AGC threshold setting may be maintained notwithstanding a presence of self-sourced intermodulation products when a desired level of quality for the desired wireless signal is also presently being attained. As another example, a present AGC threshold setting may be adjusted to alter the point at which an AGC circuit engages in the presence of such self-sourced intermodulation products when a desired level of quality for the desired wireless signal is presently not being attained.

In the usual understanding of receiver-induced (that is, self sourced and/or self generated) intermodulation products, the generation of any and all intermodulation products in a radio receiver system is to be strictly avoided. For the purposes of understanding the concepts introduced here, however, intermodulation products can be viewed or defined as being destructive or non-destructive. In the case of the former, two or more carrier-based or received energy terms, whether they be desired modulation terms or undesired adjacent or further-removed radio frequency and / or intermediate frequency terms, will in fact produce undesired products in amplifiers that are driven beyond their linear range. When such terms are within the bearer channel that is utilized by the radio system, they are termed destructive in nature since they will interfere with the proper detection and demodulation of the information on the channel. When the intermodulation terms generated by non-linear operation of the intermediate frequency and / or radio frequency amplifier stages in a radio receiver do not fall within the channel of interest, however, they are considered non-destructive and their existence is tolerated in a system that employs the teachings described herein.

In a conventional receiver system, the automatic gain control system employed to protect the low noise amplifier or mixer in the front-end of a receiver or subsequent intermediate frequency stages is generally set to engage at a level at which each of the above-listed stages will only operate within their linear range. Unfortunately, a strong undesired signal will cause the system gain to be reduced, which may also be viewed as attenuation being introduced into the system due to the action of protecting the front-end and IF stages. As the strong undesired signal is reduced in level, the desired weak signal will also be attenuated (by being reduced in level). This, in turn, adversely affects the signal to noise performance of the desired signal.

At a given point of attenuation, dependant upon the modulation method employed, the desired signal will be too weak to properly demodulate. In the disclosed system, the gain of these stages is not reduced until destructive intermodulation distortion is detected. When non-destructive intermodulation distortion is detected alone, the system will not reduce the signal to noise ratio, therefore effectively preserving the quality of the desired signal. The resultant performance can be a substantial increase in effective dynamic range of the receiver system, often on the order of tens of decibels.

A distinction can therefore be usefully drawn between what amounts to destructive intermodulation artifacts and non-destructive intermodulation artifacts (wherein the latter can comprise, for example, intermodulation products that tend to fall outside of a final band of interest prior to demodulation). By differentiating this information in this manner, one can avoid permitting an AGC to clamp down unnecessarily notwithstanding the presence of a relatively strong interfering signal. In fact, if desired, these teachings can be employed to permit an AGC threshold to actually be further released notwithstanding such operational circumstances when such an action tends largely to only lead to intermodulation products that do not actually significantly impact the desired signal.

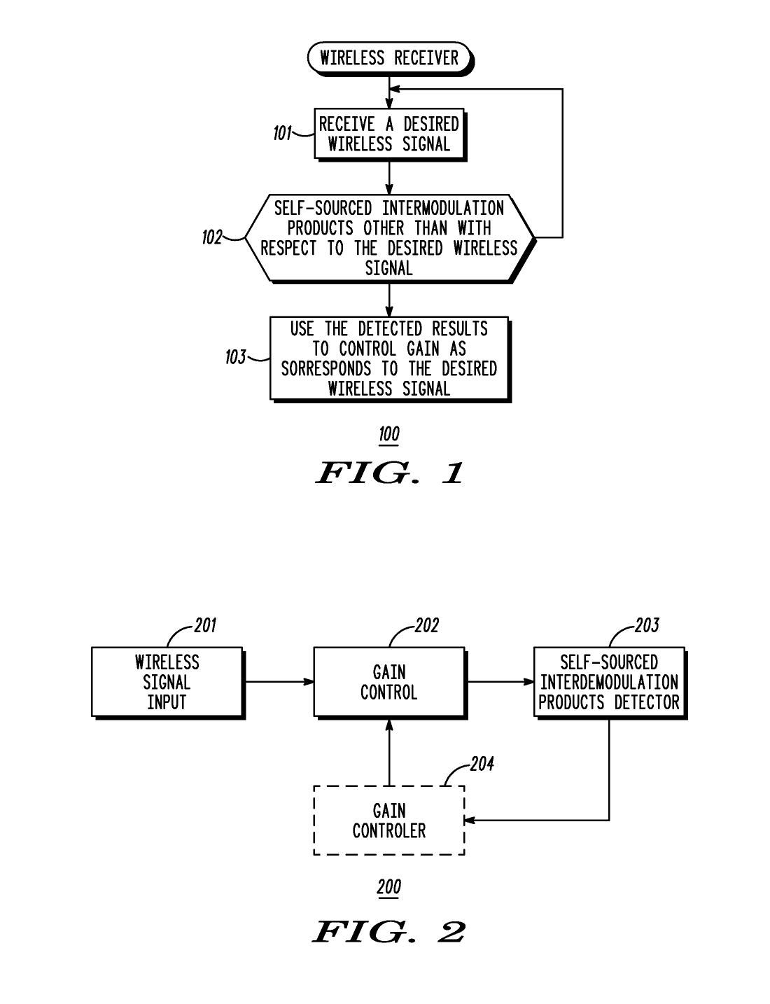

These and other benefits may become clearer upon making a thorough review and study of the following detailed description. Referring now to the drawings, and in particular to FIG. 1, an illustrative process 100 in this regard will be described. Pursuant to this process 100, a wireless receiver of choice receives 101 a desired wireless signal. This wireless receiver then detects 102 whether self-sourced intermodulation products (other than with respect to the desired wireless signal) are present (either at all or with respect to some threshold level of choice).

By one approach, this detection 102 can comprise directly detecting the self-sourced intermodulation products of interest. There are various ways by which this can be readily accomplished. By one approach, this can comprise detecting the self-sourced intermodulation products on a channel other than a channel that carries the desired wireless signal. As one example in this regard, this can comprise a channel that is adjacent to the channel that carries the desired wireless signal (where the aforementioned detection comprises, for example, detecting a rate of change of increase of noise in one or more channels that are adjacent to a channel that carries the desired wireless signal).

In a radio system, as the large signal dynamic range limit is reached, one or more stages will typically begin to operate in a non-linear fashion and produce several corresponding products. These include intermodulation terms (which we wish to detect) as well as cross-modulated noise products and self-generated noise products (the latter due to operation of one or more amplifier stages above their designed amplitude or power limits). Those skilled in the art of radio frequency and/or intermediate frequency amplifier design will understand that an amplifier driven into a non-linear region will contribute an increase in noise and distortion to the system.

Such channels can comprise channels such as a pilot carrier as comprises a part of a multicarrier, such as an orthogonal frequency division multiplexing (OFDM) approach or an orthogonal frequency division multiple access (OFDMA) approach, that bears the desired wireless signal. As another example, this can comprise an empty carrier as comprises a part of a multicarrier system such as OFDM that bears the desired wireless signal.

In the example of the empty carrier slot, the IM products will show up as additional noise in the empty carrier (null carrier) location. A demodulator that utilizes fast Fourier transform (FFT) to convert the signal from the time domain to the frequency domain will have energy present in a so-called FFT “bin” (carrier location) when it should be substantially void of energy. Differential measurement of the energy in a null carrier location can be utilized to determine an increase in noise at that carrier location. The rate of change can be used to refine the estimate of intermodulation products that have been generated and are present in the system.

By yet another approach, such detection can comprise directly detecting the self-sourced intermodulation products on a guardband that comprises a part of a channel that carries the desired wireless signal. The IM products are detected in the same manner as that utilized for the missing pilot or carrier location method already discussed. Essentially, energy will be detected at a frequency location where energy above a predetermined level should not be present. Guardbands are often utilized in multicarrier as well as single carrier RF systems to provide protection to adjacent channel services. These guardbands can be utilized to detect the generation of intermodulation products much as described in the empty or null carrier example, above.

Such concepts and characteristics as adjacent channels, pilot carriers, multicarriers, empty carriers, and guardbands are well known in the art. Furthermore, these present teachings are not especially sensitive to the selection of any particular approach in this regard. Therefore, for the sake of brevity and in the spirit of clarity no further elaboration regarding such points are presented here.

This process 100 will also readily accommodate affecting such detecting 102 via indirect detection of the self-sourced intermodulation products. Again, there are various ways by which such indirect detection can be accomplished. By one approach, this can comprise assessing the quality of the desired wireless signal itself. By another approach this can comprise assessing a bit error rate as corresponds to the desired wireless signal and comparing that bit error rate against expected bit error rate performance for a given corresponding signal strength. As yet another approach, this can comprise detecting a rate of change as corresponds to a modulation envelope as corresponds to the desired wireless signal (in a setting where modulated envelopes comprise at least a part of the information bearing transmitted content as in a quadrature amplitude modulation-based system). The rate of change will be different in the case of an IM product as opposed to co-channel interference.

Other possibilities for indirectly detecting such products exist as well. For example, such indirect detection can be based upon one or more of inter-symbol interference levels, which may be indirectly inferred from bit error rate or detected by other means, a rate of change of noise on a given pilot carrier, and/or errors on known symbols. Again, such concepts are, in and of themselves, well understood in the art and require no further description here.

In many application settings it may be useful to effect such detection 102 using more than one category or kind of approach to detection. This can comprise using more than one kind of approach to directly detecting self-sourced intermodulation products, more than one kind of approach to indirectly detecting such products, or a mixture of direct and indirect approaches for detecting such self-sourced intermodulation products.

This process 100 then provides for using 103 the detected results to control gain as corresponds to the desired wireless signal. By one approach, for example, this can comprise adjusting an AGC threshold for one or more AGC functions in the receiver (and particularly prior to demodulation). If desired, such usage 103 can also take into account a measure of a level of quality as corresponds to the desired wireless signal itself (such as, but not limited to, bit error rate, signal to noise ratio, and so forth). So configured, for example, this usage 103 can comprise maintaining a present AGC threshold when the detected results indicate a presence of self-sourced intermodulation products but at least a desired level of quality as corresponds to the desired wireless signal is presently being attained. Such a practice, of course, runs contrary to traditional practice in this regard for the most part but serves a useful and beneficial purpose here.

As another example in this regard, such usage 103 can comprise reducing a present AGC threshold when the detected results indicate a presence of self-sourced intermodulation products along with a failure to presently attain at least a desired level of quality as corresponds to the desired wireless signal. So configured, the detection of self-sourced intermodulation products that are off-channel with respect to the wireless signal of interest serves to dynamically inform the automated control of gain as corresponds to the processing of that signal. The presence of such artifacts, when properly taken into account, permit one to maintain (or even, if desired, to further decrease) the AGC point of engagement (reducing the overall gain of the system) under circumstances when one might otherwise increase that threshold to the significant detriment of properly receiving the desired wireless signal.

Those skilled in the art will appreciate that the above-described processes may be enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

In the illustrative example, the apparatus 200 comprises a wireless receiver having a wireless signal input 201 of choice that operably couples to a gain control 202 and to a self-sourced intermodulation products detector 203 of choice. The gain control 202 can comprise, for example, an AGC that is operably responsive to the self-sourced intermodulation products detector 203. This operable responsivity can be achieved, for example, via use of a gain controller 204.

The self-sourced intermodulation products detector 203 can be configured and arranged as desired to directly and/or indirectly detect such products in accordance with the teachings set forth above. The gain controller 204, in turn, can be operably coupled to both the self-sourced intermodulation products detector 203 and the gain control 202 and can be configured and arranged to control a gain threshold for the latter as a function of information regarding self-sourced intermodulation products as provided by the self-sourced intermodulation products detector 203 and information regarding quality of a desired received wireless signal as described above.

Those skilled in the art will recognize and understand that such an apparatus 200 may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially programmable platform as are known in the art.

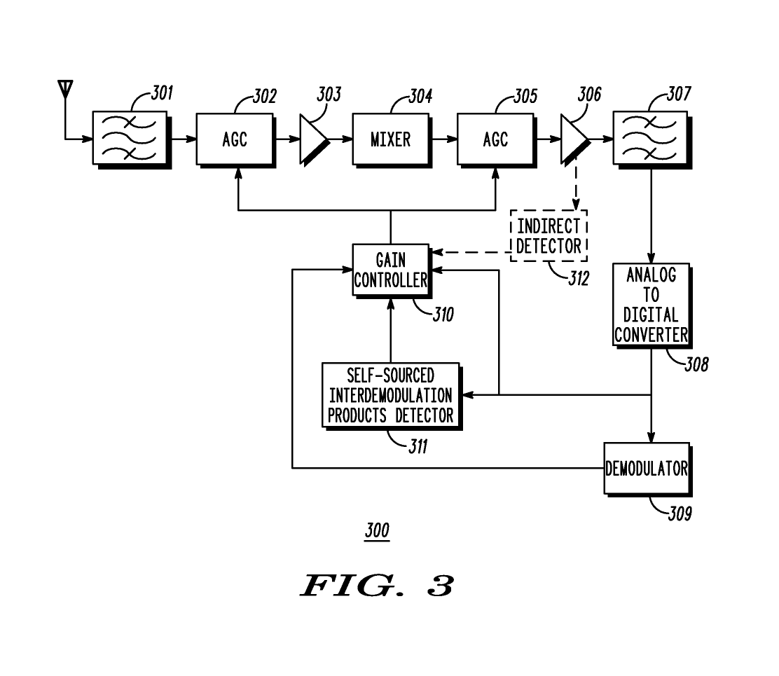

Referring now to FIG. 3, a more specific illustrative embodiment will be described. In this example, a wireless receiver 300 receives a wireless signal through an initial wide band pass filter 301 and provides the filtered results to a first AGC 302. The output of this first AGC 302 feeds a radio frequency amplifier 303 that in turn provides an amplified result to a mixer 304. A second AGC 305 receives the mixer 304 output and provides a gain controlled result to an intermediate frequency amplifier 306. The output of the intermediate frequency amplifier 306 in turn feeds another filter 307 whereupon an analog-to-digital converter 308 digitizes the processed signal(s) and feeds them to a demodulator 309. These components and their manner of operation in such a configuration are all well understood in the art and require no further description here.

Threshold levels for both AGC's 302 and 305 are controlled by a gain controller 310. This gain controller 310 responds to the outputs of the analog to digital converter 308 and the demodulator 309 in accordance with prior art practice in this regard, but also responds here to a self-sourced intermodulation products detector 311. The latter serves, in this example, to effect direct detection of such self-sourced intermodulation products using one or more techniques of choice. So configured, the gain controller 310 is configured and arranged (via, for example, programming in accordance with the teachings set forth above) to use information regarding self-sourced intermodulation products when effecting control of the AGC thresholds.

As mentioned above, such control can also be a function of indirect detection of such self-sourced intermodulation products, either in combination with direct detection of such products or in lieu thereof Accordingly, if desired, an indirect detector 312 of such circumstances can be operably coupled, for example, between the intermediate frequency amplifier 306 and the gain controller 310 to affect such a capability.

So configured, those skilled in the art will recognize and appreciate that a relatively weak signal can be processed with an increased or even effectively maximized signal to noise ratio so long as that weak signal is not directly interfered with by receiver-generated intermodulation products. This, in turn, represents a considerable improvement over the typical performance of prior art platforms in this regard.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

We claim:

1. A method comprising:
in a wireless receiver:
receiving a desired wireless signal;
detecting self-sourced intermodulation products to provide detected results;
using the detected results to control gain as corresponds to the desired wireless signal.

2. The method of claim 1 wherein detecting self-sourced intermodulation products to provide detected results comprises directly detecting the self-sourced intermodulation products.

3. The method of claim 2 wherein directly detecting the self-sourced intermodulation products comprises detecting the self-sourced intermodulation products on a channel other than a channel that carries the desired wireless signal.

4. The method of claim 3 wherein the channel other than a channel that carries the desired wireless signal comprises at least one of:
a channel that is adjacent to the channel that carries the desired wireless signal;
a pilot carrier as comprises a part of a multicarrier that bears the desired wireless signal;
an empty carrier as comprises a part of a multicarrier that bears the desired wireless signal.

5. The method of claim 2 wherein directly detecting the self-sourced intermodulation products comprises detecting the self-sourced intermodulation products on a guardband as comprises a part of a channel that carries the desired wireless signal.

6. The method of claim 2 wherein directly detecting the self-sourced intermodulation products comprises detecting a rate of change of increase of noise in at least one channel that is adjacent to a channel that carries the desired wireless signal.

7. The method of claim 1 wherein detecting self-sourced intermodulation products other than with respect to the desired wireless signal to provide detected results comprises indirectly detecting the self-sourced intermodulation products.

8. The method of claim 7 wherein indirectly detecting the self-sourced intermodulation products comprises at least one of:
assessing quality of the desired wireless signal;
assessing a bit error rate as corresponds to the desired wireless signal and comparing that bit error rate against expected bit error rate performance for a given corresponding signal strength;
a rate of change as corresponds to a modulation envelope as corresponds to the desired wireless signal;
inter-symbol interference levels;
rate of change of noise on pilot carriers;
errors on known symbols.

9. The method of claim 1 wherein detecting self-sourced intermodulation products other than with respect to the desired wireless signal to provide detected results comprises both directly and indirectly detecting the self-sourced intermodulation products.

10. The method of claim 1 wherein using the detected results to control gain as corresponds to the desired wireless signal comprises adjusting an Automatic Gain Control threshold.

11. The method of claim 10 wherein using the detected results to control gain as corresponds to the desired wireless signal further comprises at least maintaining a present Automatic Gain Control threshold when the detected results indicate a presence of self-sourced intermodulation products but at least a desired level of quality as corresponds to the desired wireless signal is presently attained.

12. The method of claim 11 wherein using the detected results to control gain as corresponds to the desired wireless signal further comprises reducing the present Automatic Gain Control point of engagement when the detected results indicate a presence of self-sourced intermodulation products and at least a desired level of quality as corresponds to the desired wireless signal is presently not being attained.

13. A wireless receiver comprising:
a wireless signal input;
a self-sourced intermodulation products detector that is configured and arranged to detect self-sourced intermodulation products;
a gain control that is operably coupled to the wireless signal input and that is responsive to the self-sourced intermodulation products detector.

14. The wireless receiver of claim 13 wherein the self-sourced intermodulation products detector is configured and arranged to directly detect the self-sourced intermodulation products.

15. The wireless receiver of claim 14 wherein the self-sourced intermodulation products detector is further configured and arranged to detect the self-sourced intermodulation products on a channel other than a channel that carries the desired wireless signal.

16. The wireless receiver of claim 14 wherein the self-sourced intermodulation products detector is further configured and arranged to detect the self-sourced intermodulation products using at least two different detection techniques.

17. The wireless receiver of claim 13 wherein the self-sourced intermodulation products detector is further configured and arranged to indirectly detect the self-sourced intermodulation products.

18. The wireless receiver of claim 13 wherein the gain control comprises an Automatic Gain Control.

19. The wireless receiver of claim 18 further comprising:
a gain controller that is operably coupled to the self-sourced intermodulation products detector and to the Automatic Gain Control and is configured and arranged to control a gain threshold of the Automatic Gain Control as a function of:
information regarding self-sourced intermodulation products as provided by the self-sourced intermodulation products detector; and
information regarding quality of the desired received wireless signal.
